(19) United States
(12) Patent Application Publication
(10) Pub. No.: US 2010/0143632 A1
(43) Pub. Date: Jun. 10, 2010

(54) COATING COMPOSITION COMPRISING POLYETHYLENIMINE AND POLY(METH)ACRYLIC ACID

(75) Inventors: FARID DJENADI, Aulnay-sous-Bois (FR); Stephan Hüffer, Munchen (DE); Helmut Witteler, Wachenheim (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/631,140

(22) Filed: Dec. 4, 2009

(30) Foreign Application Priority Data
Dec. 5, 2008 (EP) 08170833.1

(51) Int. Cl. B32B 1/08; C08L 33/02; B32B 15/082

(52) U.S. Cl. 428/36.91; 525/217; 524/521; 428/461

(57) ABSTRACT

A composition comprising polyethylenimine, poly(meth)acrylic acid or salts thereof and, if appropriate, auxiliaries and additives typical for coating materials or paints, and also solvents, is used for corrosion control for the coating of carbon steel/black steel.

### CROSS-REFERENCE TO RELATED APPLICATIONS

This application claims the benefit of priority under 35 U.S.C. §119 to European Patent Application No. 08170833.1, filed on Dec. 5, 2008, the entire contents of which is incorporated herein by reference.

### FIELD OF THE INVENTION

The invention relates to a coating composition intended in particular for sheets of carbon steel or black steel.

### BACKGROUND

Corrosion control may be accomplished by a variety of methods in the context of iron and steels. A widespread method of corrosion control is the galvanizing of steel. This technique is frequently employed in particular in automotive engineering. Further possibility is the application to the steel surface of polymer-based protective coats. In this context, in particular, surface coatings, and especially anticorrosion coatings, are contemplated.

The use of polyethylenimines as corrosion inhibitors is known from Corrosion Science 37 (1995), pages 975 to 985, for example. They may be used, together with other materials, for coating metal sheets as well. For example, U.S. Pat. No. 6,448,313 describes aqueous compositions which comprise polyvinyl alcohol and may further comprise polyethylenimine, for the temporary protective coating of metal sheets.

### BRIEF SUMMARY

Disclosed herein are corrosion inhibitors for coating (untreated) iron and steel sheets, profiles, tubes or shaped articles. The corrosion inhibitors may be applied to the metal surface in a simple way and provide a high level of corrosion control.

This object is achieved by means of a composition comprising polyethylenimine, poly(meth)acrylic acid or salts thereof, and, if appropriate, auxiliaries and additives typical for coating materials or paints, and additionally solvents.

It has been found that compositions comprising polyethylenimine and poly(meth)acrylic acid or salts thereof are particularly suitable for the corrosion-control coating of iron or steel objects.

In one embodiment, the compositions comprise polyethylenimine, poly(meth)acrylic acid or salts thereof, and, if appropriate, auxiliaries and additives typical for coating materials or paints, and also (if appropriate) solvents. The composition may comprise the stated ingredients. Preferably, the composition comprises no polyvinyl alcohol.

In another embodiment, the composition additionally comprises substantially no further plastics or polymers. Among the auxiliaries and additives there may also be polymeric structures present, provided they are not used primarily as a coating material to cover the metal surface. Typically these additional polymeric structures are present in maximum amounts of not more than 5% by weight each, preferably not more than 1% by weight each, in the compositions. Preferably there are only polyethylenimine and poly(meth)acrylic acid or salts thereof comprised as coating-forming polymers in the compositions.

Also disclosed herein are paints or varnishes and coating materials or agents that comprise the compositions.

### DETAILED DESCRIPTION OF THE PREFERRED EMBODIMENTS

Polyethylenimine has a branched structure as an inevitable result of its synthetic process. Reference may be made to the entry on “polyethylenimine” in Römpp Chemielexikon, 9th edition. The polyethylenimine preferably has a weight-average molecular weight in the range from 800 to 750,000, more preferably 900 to 50,000, more particularly 1,000 to 5,000. It may be used with a water content of 1% to 95% by weight and hence as a solid, as an aqueous mixture or as an aqueous solution. The pH of an aqueous polyethylenimine solution is preferably from 7 to 13, and more preferably from 10 to 12. Suitable polyethylenimines are available under the brand name Lupasol® from BASF SE. The pH of the polyethylenimines may be adjusted, for example, by adding organic acids such as acetic add.

The term “poly(meth)acrylic acid” describes polyacrylic acids and polymethacrylic acid. It is preferred to use polyacrylic acid or salts of polyacrylic acid. The poly(meth)acrylic acid here may be wholly or partly neutralized by alkalis. Typically, the poly(meth)acrylic acid is present in a partly or wholly neutralized form, neutralized by sodium hydroxide solution, potassium hydroxide solution or ammonia, and, more particularly, by a sodium hydroxide solution. The poly(meth)acrylic acid or salts thereof may have a water content of 3% to 95% by weight, based in each case on the composition comprising poly(meth)acrylic acid or salt thereof and water. Suitable polyacrylic acids or salts thereof are available under the brand name Sokalan® from BASF SE. An aqueous poly(meth)acrylic acid solution preferably has a pH in the range from 3 to 10, and more preferably 3 to 8.

The preferred poly(meth)acrylic acids or salts thereof have a weight-average molecular weight of 1,000 to 350,000, preferably 2,000 to 250,000, and more preferably 5,000 to 200,000.

Lupasol G 35 from BASF SE has, for example, a weight-average molecular weight of 2,000 g/mol and, as a 50% strength by weight aqueous solution, has a pH of 11. Sokalan TA 80 S from BASF SE has a weight-average molecular weight of 100,000 g/mol and, as a 35% strength by weight aqueous solution, has a pH of 2. Sokalan TA 30 BN has a weight-average molecular weight of 8,000 and, as a 49% strength by weight aqueous solution, has a pH of 4. Sokalan PA 30 has a weight-average molecular weight of 8,000 and, as a 45% strength by weight aqueous solution, has a pH of 8.

The polyethylenimine described herein is a branched polyethylenimine, whereas the polyacrylic acid is a linear polyacrylic acid.

The weight-average molecular weights of the polyethylenimine and of the poly(meth)acrylic acids or salts thereof are different from one another by a factor of not more than 20, preferably by a factor of not more than 10, and more preferably by a factor of not more than 5.

Polyethylenimine and poly(meth)acrylic acid or salts thereof are used preferably in a weight ratio of 20% to 60% by weight, preferably 30% to 50% by weight, especially about 40% by weight polyethylenimine to 40% to 80% by weight, more preferably 50% to 70% by weight, more particularly about 60% by weight poly(meth)acrylic acid or salts thereof. Frequently it is preferred to use equivalent amounts of polyethylenimine and poly(meth)acrylic acid, based on the respective end groups.

The composition has a water fraction of 0% to 95%, preferably 50% to 93%, and more preferably 75% to 90%, by weight, based on the overall composition.

Besides polyethylenimine and poly(meth)acrylic acid or salts thereof, as main ingredients, and solvents, especially aqueous solvent, more particularly water, it is possible for there to be further auxiliaries and additives present in small amounts. The auxiliaries and additives are the auxiliaries and additives that are known from coating materials or paints. They may be, for example, surface-active substances (surfactants), wetting agents, additional, low molecular mass corrosion inhibitors such as alkanolamines, viscosity modifiers or rheology modifiers, thickeners, pigments, dyes, inorganic fillers, etc.

Suitable surfactants are described in U.S. Pat. No. 6,448,313, at column 2 line 31 to column 3 line 18. Additional corrosion inhibitors are described in U.S. Pat. No. 6,448,313 at column 3 line 19 to column 4 line 19. Viscosity or rheology modifiers and thickeners are described, for example, in U.S. Pat. No. 6,448,313 at column 4 line 36 to column 5 line 10. Water-miscible organic solvents such as monohydric and polyhydric alcohols are described in U.S. Pat. No. 6,448,313 at column 4 lines 20 to 36. The entire disclosure of U.S. Pat. No. 6,448,313 is incorporated herein by reference.

Fillers may, for example, be mineral fillers such as inorganic metal oxides. Additionally, glass fibers, carbon fibers, and similar reinforcing agents may be used as additives as well.

The compositions described herein may be produced by mechanical mixing of the solid or fluid ingredients. If the compositions are water-free or have a low water content, they may be mixed, for example, in kneading apparatus or in extruders. Aqueous solutions may be mixed using typical mixers for fluid systems.

Preference is given to using polyethylenimine, poly(meth)acrylic acid or salts thereof, and water in amounts such as to give a homogeneously mixed solution.

Without being tied to any one theory, it is assumed that polyethylenimine and poly(meth)acrylic acid form a polycomplex. The three-dimensional superstructure of the polycomplex is dependent on the pH. The formation of amide bonds is typically not observed. For example, at an acidic pH, the linear polyacrylic acid may be present in the form of a random coil surrounded by charged polyethylenimine macromolecules. At basic pH values, an elongated coil may be produced, which enters into salt bonds with polyethylenimine. The polyethylenimine/poly(meth)acrylic acid complexes are water-soluble, and so homogeneous aqueous solutions are obtainable of the compositions.

It is preferred to use polyethylenimine and poly(meth)acrylic acid in amounts such that salts or polycomplexes are formed.

The compositions are used to coat metals preferably in a form in which the compositions are fluid at room temperature. They are therefore fluid or paste-like at room temperature (22° C.).

The compositions are used preferably for coating iron or steel sheets, profiles, tubes or shaped articles. In these applications the compositions serve primarily for corrosion control. More particularly, the compositions are used for coating carbon steel/black steel, which, unlike stainless steel, lack inherent corrosion resistance. The compositions are preferably applied to iron or steel that has not been corrosion-protected beforehand, by having been galvanized, for example. Even stainless steels may be protected even more effectively against corrosion—chloride corrosion, for example—by the composition. Preferably, ungalvanized steel is protected from corrosion using the composition.

An iron or steel sheet, profile, tube or a corresponding shaped article having a superficial coating is provided, on at least 30% of the surface, preferably at least 50% of the surface, and more preferably at least 80% of the surface, comprising a composition as described above. The coat thickness in this case is preferably in the range from 200 nm to 25 μm, and more preferably 0.5 nm to 10 μm. The composition may be applied to the metal surface by means of any desired and suitable techniques, such as, for example, by knifecoating, spraying or dip coating. By way of example, a steel sheet may be immersed into a liquid composition, and then squeezed off to the desired coat thickness using a squeeze roll.

In general this is followed by a temperature treatment of the coated iron or steel material in order to remove solvent from the composition and to improve the attachment of the coating. The aqueous solvent may be removed, for example, by freeze-drying or by heating to temperatures of up to 250° C. Heating takes place typically for periods of a minute to several minutes at a temperature in the range from 50 to 200° C. For example, heating is carried out for one minute at 80° C. for a coat thickness of 2 to 4 μm.

Prior to the coating operation, the iron or steel surface may be prepared. Preferably it is subjected to mild-alkaline cleaning and, if appropriate, degreasing. This may be done by means of a dip bath or else an ultrasound bath.

The corrosion control coating may have typical further coatings applied to it, such as finishes or other ornamentations. The application of adhesive bonds is also possible.

The metal sheets, profiles, tubes or shaped articles for coating may come from a multiplicity of fields of application. Ungalvanized steel sheets are used typically in the production of trucks and agricultural machinery, and in the production of load-bearing construction elements or steel girders, steel grid meshes or steel grid reinforcements for the construction sector. Particularly for concrete reinforcements composed of steel grid meshes or filigree steel grid meshes, or else for steel girders for concrete reinforcement, the compositions may be employed with great advantage. This allows the durability of the steel reinforcements in steel-reinforced concrete components to be increased considerably.

Furthermore, it is possible to apply removable transport protection to iron or steel surfaces. One example is the transport protection of the steel coils whereby the steel coils are protected from external influences and corrosion in the course of transportation up until the end application. The coatings may then be removed again from the iron or steel surfaces by cleaning methods or mechanical ablation. The disclosures provided herein are illustrated by the examples below.

### Example 1

Coating is carried out using a composition of 4.5 g of Lupasol G 35 from BASF SE (50% strength by weight aqueous solution), 0.5 g of Sokalan PA 30 from BASF SE (35% strength by weight aqueous solution) with 5 g of water. Using a quadruple film applicator from Erichsen, a thin film of the composition is applied to two Gardobond® sheets, with a coat thickness of 60 μm. The carbon steel sheets are produced by Chemmetall AG and sold under the name Gardobond® OC. The first sheet was then dried at room temperature, the second sheet at 120° C. in an oven for 1 hour.

The corrosion resistance was determined by means of the salt spray test in a salt spray chamber over the course of 24 hours. The salt spray test is a standardized test method for investigating the corrosion resistance of coated samples. It uses a closed test chamber into which a salt water solution is sprayed through a nozzle. Tests using a sodium chloride solution are known as NS (neutral salt spray). In accordance with ISO 9227 the test time in hours is reported for which there were no corrosion products.

Furthermore, the samples are investigated in a controlled-climate chamber in order to investigate the resistance with respect to humidity. The investigation took place in accordance with ISO 6270-2, part 2, 2005. The investigation took place at a temperature of 40° C. The corrosion resistance was then investigated in accordance with ISO 10289 (2001). The sheets were assessed in accordance with Appendix B of ISO 10289.

In addition, the water contact angle was ascertained. The untreated sheet gave a contact angle of 49°, the sheet dried at room temperature 14.14°, and the sample dried in an oven at 120° C. for an hour an angle of 23.07°.

The result was substantially improved corrosion control through application of the composition.

### Example 2

Coating took place as in example 1 but using 5 g each of Lupasol G 35 and Sokalan PA 30 and 9 g of water. Coating took place as described in example 1 with a film thickness of 100 μm. After the coating operation, the sheets were dried in an oven at 40° C. for 3 hours. Alternatively a film thickness of 20 to 25 μm was applied, and was reduced to an ultimate film thickness of 2 to 4 μm using squeeze rolls.

Drying was carried out in a ventilated oven at 80° C. for 1 minute.

The corrosion tests by salt spray and humidity again showed a considerably improved corrosion resistance as compared with an untreated steel sheet.

1. A composition comprising:
polyethylenimine; and
poly(meth)acrylic acid or salts thereof.

2. The composition of claim 1 further comprising one or more additives and auxiliaries typical for coating materials or paints and a solvent.

2. The composition of claim 1, wherein the polyethylenimine is in the form of an aqueous mixture having a water content in the range from about 1% to 95% by weight and wherein the poly(meth)acrylic acid or salts thereof is in the form of an aqueous mixture having a water content of 3% to 95% by weight.

3. The composition of claim 1, wherein the polyethylenimine and the poly(meth)acrylic acid or salts thereof have a weight ratio of 20% to 60% by weight polyethylenimine and 40% to 80% by weight poly(meth)acrylic acid or salts thereof.

4. The composition of claim 1, wherein the composition comprises a water fraction of 50% to 93% by weight of the composition.

5. The composition of claim 1, wherein the polyethylenimine has a weight-average molecular weight of from 800 to 750,000 and the poly(meth)acrylic acid or salts thereof has a weight-average molecular weight of from 1,000 to 350,000.

6. The composition of claim 1, wherein the weight-average molecular weights of the polyethylenimine and of the poly(meth)acrylic acid or salts thereof are different from one another by a factor of not more than 20.

7. A method of producing a composition of claim 1 by mechanical mixing of the solid or fluid ingredients.

8. An iron or steel sheet, profile, tube or shaped article having a superficial coating on at least 30% of the surface, comprising a composition of claim 1.
